(19) United States
(12) Patent Application Publication
(10) Pub. No.: US 2011/0133877 A1
(43) Pub. Date: Jun. 9, 2011

(54) Stacked inductor with multi paths for current compensation

(76) Inventors: Tzuyin CHIU, Shanghai (CN); Xiangming Xu, Shanghai (CN); Miao Cai, Shanghai (CN)

(21) Appl. No.: 12/960,133

(22) Filed: Dec. 3, 2010

(30) Foreign Application Priority Data
Dec. 8, 2009 (CN) 200910201902.0

(51) Int. Cl. H01F 5/00

(52) U.S. Cl. 336/200

(57) ABSTRACT

A multi-path stacked inductor for current compensation is represented in this invention. This structure includes top and bottom metal trace, which are aligned with each other. Each metal trace consists of multi paths. The inner path in top metal flips over to the outer path in the bottom metal, while the outer path in top metal flips over to the inner path in the bottom metal. These paths join together at the end of the metal trace with via holes. Skin effect and current crowding effect are reduced by means of this method. This stacked inductor possesses larger inductance than single layer spiral inductor, with relatively higher Q factor.

The current invention claims a foreign priority to China application 200910201902.0 filed on Dec. 8, 2009.

### FIELD OF THE INVENTION

The invention is related to micro-electronics and more particularly to realizing high Q on-chip stacked inductor for RF application.

### BACKGROUND OF THE INVENTION

In present, there are a lot of passive devices in the integrated circuits. One of the most important components in RF CMOS/BiCMOS integrated circuits is on-chip inductor. Inductor has great impact on the RF characteristic in common wireless product. The design and analyze for this component has been widely researched as a result. Nowadays, the high Q on-chip inductor has been widely used in voltage controlled oscillator, low noise amplifier and other RF building blocks. On-chip stacked inductor reduced chip area in a large extent, which reduced the production cost.

Q factor is the major specification of the inductor, high Q means low loss and high efficiency. Q factor is derived by:

$$Q \approx \frac{wL}{{R}_{s}} \qquad Equation 1$$

Q is quality factor, w is frequency, L is inductance under a certain frequency, Rs is resistance under a certain frequency.

The mutual inductance of the top and bottom metal trace efficiently improves the total inductance in a large extent, however, the ΔRs (increased parasitic resistance) should be reduced as much as possible.

Because of skin effect, current flows at the surface of the metal trace at high frequency, the metal resistance is changed along with frequency. The skin effect formulation for resistance is:

$${R}_{s} \approx \frac{l}{w \cdot σ \cdot δ ( 1 - {e}^{- t / δ} )} \qquad Equation 2$$

In this formulation, α is the resistivity of material, 1 is the total length of metal trace, w is the metal width and t is the metal thickness. The skin depth δ is:

$$δ = \sqrt{\frac{2}{ω \cdot μ \cdot σ}} \qquad Equation 3$$

In this formulation, μ is permeability, σ is conductivity, ω is angular frequency. Suppose the conductivity of the metal material is 3e7 siemens/m, the skin depth is 2.1 um at 2 GHz.

Because of skin effect, the resistance of metal trace will not drop substantially with the increase of metal width. However, the resistance is reduced significantly by open slot in the metal, which increases the current paths.

When the high frequency current flows in adjacent metal trace, it is not only in the electromagnetic field generated by the self current, but also in the electromagnetic field generated by current in other trace. In other words, the current distribution is affected by the adjacent metal trace. As a result, the inner current is larger than the outer current, as the shown in FIG. 9. Sometimes the outer current is zero or negative because of current crowding effect.

Current crowding effect results in the non-uniformity of inner and outer of current density, which decreases the Q factor by a large extent.

Conventional stacked inductor as shown in FIG. 1 possesses large inductance. However, the current crowding effect results in the non-uniformity of the inner and outer current density, leading to the decrease of Q factor. As the result, it could not meet the requirement of circuit design.

### SUMMERY OF THE INVENTION

This invention provides a multi paths stacked inductor for current compensation, which possesses larger inductance than single layer spiral inductor with the same area, and with high Q factor.

This multi paths stacked inductor for current compensation comprises top and bottom metal trace, which is aligned with each other, each metal trace consist of multi paths. The inner path in top metal flips over to the outer path in the bottom metal, while the outer path in top metal flips over to the inner path in the bottom metal. These paths join together at the end of the metal trace with via holes.

The advantage of this invention is: can reduce the impact of skin effect and current crowding effect. This invention increases inductance in large extent, and keeps high Q factor.

### BRIEF DESCRIPTION OF THE DRAWINGS

These and other features of this invention will be more readily understood from the following detailed description of the invention in conjunction with the accompanying drawings in which:

FIG. 1 is the top-view diagram of conventional stacked inductor;

FIG. 2 is the stereogram of stacked inductor in this invention;

FIG. 3 is two paths stacked inductor top layer metal trace;

FIG. 4 is two paths stacked inductor bottom layer metal trace;

FIG. 5 is four paths stacked inductor top layer metal trace;

FIG. 6 is four paths stacked inductor bottom layer metal trace;

FIG. 7 is the Q vs frequency of conventional stacked inductor;

FIG. 8 is the Q vs frequency of multi paths stacked inductor;

FIG. 9 is the figure of current crowding effect.

### DETAILED DESCRIPTION OF THE INVENTION

This multi paths stacked inductor for current compensation comprises top and bottom metal trace, which are aligned with each other, each metal trace consists of multi paths. The inner path the inner path of the top metal trace flips over to the outer path when connected to the bottom metal trace, the outer path of the bottom metal trace flips over to the inner path when connected to the top metal trace; These paths join together at the end of the metal trace with via holes.

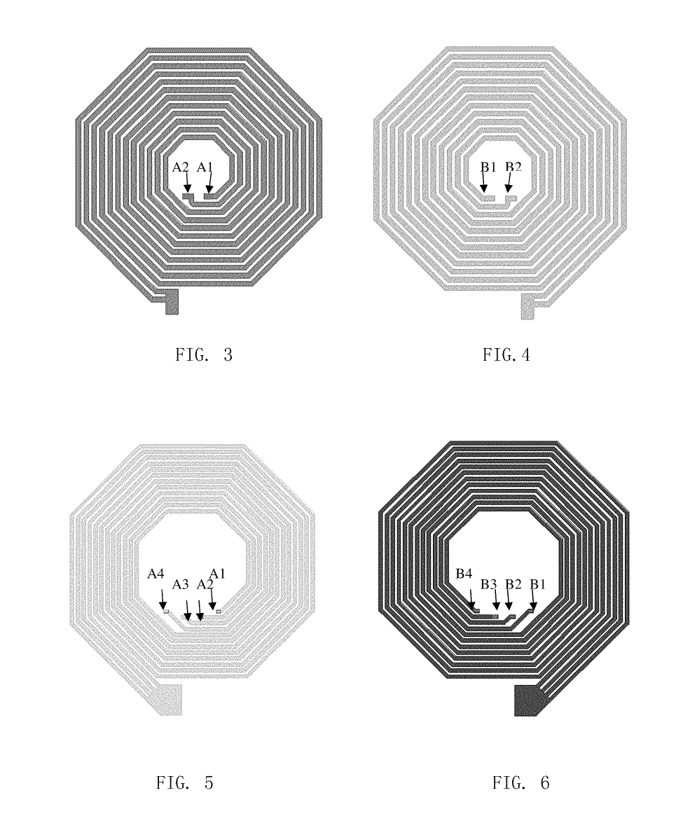

More detailed the layout of stacked inductor with top and bottom metal trace aligned with each other (taking two layer, 6 turns, and octagonal stacked inductor for example) is shown in FIG. 3 and FIG. 4, with stereogram in FIG. 2. The width and thickness of the two layer metal trace is equal in FIG. 2. Also from FIG. 2, each metal trace has multi paths, with the inner path in top metal flips over to the outer path in the bottom metal, while the outer path in top metal flips over to the inner path in the bottom metal. These paths join together at the end of the metal trace with via holes.

The flip over from inner to outer paths at the top to bottom cross is shown in FIG. 3 and FIG. 4, from A1 to B1, and A2 to B2. The current density keeps uniform in one path with this method. The mutual inductance of top and bottom metal trace achieves more than twice of the single layer spiral inductor. Further more, skin effect and current crowding effect are reduced by multi paths and flip over at the cross, which keeps high Q factor.

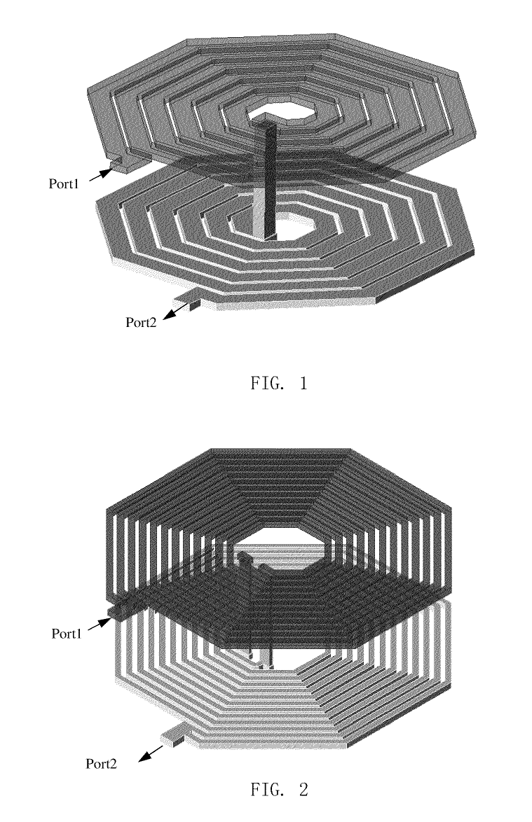

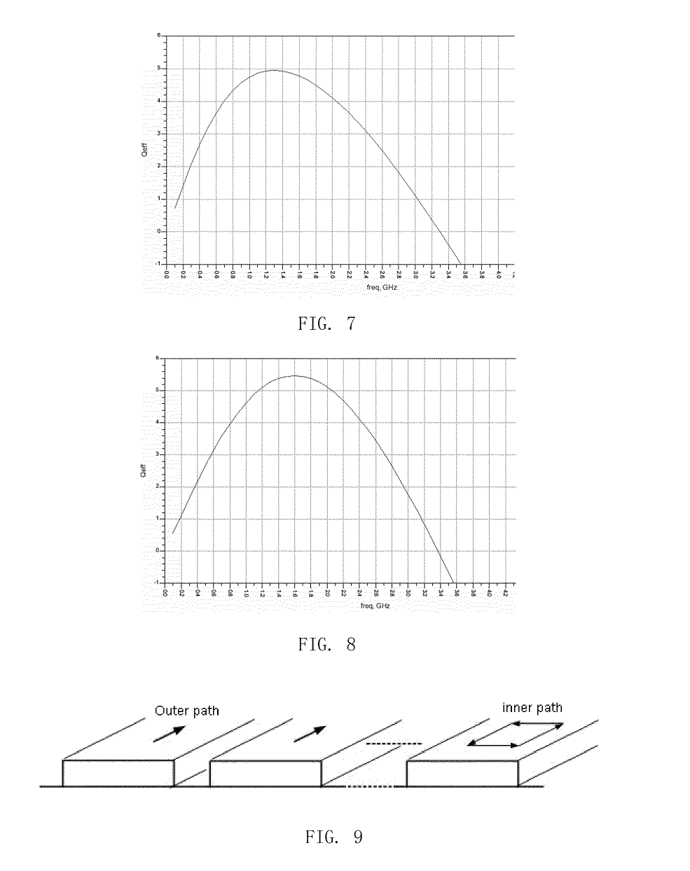

Taking a stacked inductor with outer diameter of 160 um for example, the characteristic of traditional stacked inductor is shown in FIG. 1 and new structure inductor is shown in FIG. 2. In FIG. 1, the metal width of top and bottom metal is 8 um, metal space is 2 um, with 6 turns. In FIG. 2, each metal trace is divided to two paths. With the width of each path is 3 um and space is 2 um. The Q factor of the new structure stacked inductor improves 10% from FIG. 7 and FIG. 8, with the same low frequency inductance of 11.9 nH. Miniaturization stacked inductor with large inductance and high Q factor will be realized by this method.

A method to realize this new structure stacked inductor is in the standard 6 metal layers RF integrated circuit process. Taking stacked inductor with outer diameter of 160 um for example. The top metal trace layout is shown as FIG. 3, with metal width of 8 um, space of 2 um, and turns of 6. The top metal trace is two paths parallel, that is A1 and A2, the space of each path is 2 um. The bottom metal trace layout is shown in FIG. 4, with metal width 8 um, and space 2 um, 6 turns. The top metal trace is two paths parallel, that is B1 and B2, the space of each path is also 2 um. A1 and B1 are connected, while A2 and B2 are connected by top via holes, as a result, the flip over of two paths is realized.

Alternative method is shown as FIG. 5 and FIG. 6, with each metal traced divided into 4 paths. A1 is connected with B1, A2 is connected with B2, A3 is connected with B3, and A4 is connected with B4. The flip over of four paths is realized.

The new structure of this invention can realize two paths or more paths division and flip over at the cross, compensating the inside and outside path current density, in order to improve Q factor. Neither of the number of paths or metal layers is limited in two. This invention is preferentially applied to the top metal layer and top minus one layer. However, other layers are also suitable for use.

While the invention has been particularly shown and described with reference to the preferred embodiments thereof, it will be understood by those skilled in the art that various changes in form and details may be made without departing from the spirit of the invention or from the scope of the appended claims

1. A multi-path stacked inductor for current compensation including multiple metal layers comprises:
stacked top and bottom metal traces and the top and bottom metal traces are aligned with each other;
each of the metal traces comprises of multiple paths;
the inner path of the top metal trace flips over to the outer path when connected to the bottom metal trace;
the outer path of the bottom metal trace flips over to the inner path when connected to the top metal trace; and
the top and bottom metal layers being connected with via holes.

2. The multi-path stacked inductor for current compensation of claim 1 comprises: each of the metal traces comprises of top and bottom metal layers.

3. The multi-path stacked inductor for current compensation of claim 1 comprises: each of the metal traces comprises of two paths.

4. The multi-path stacked inductor for current compensation of claim 1 comprises: each of the metal traces comprises of four paths.

5. The multi-path stacked inductor for current compensation of claim 1 comprises: the line widths of the top and bottom metal traces are equal.

6. The multi-path stacked inductor for current compensation of claim 1 comprises: the metal thicknesses of the top and bottom metal traces are equal.

7. The multi-path stacked inductor for current compensation of claim 1 comprises: the shape of the stacked inductor is selected from the group consisting of octagon, polygon or circle.

8. The multi-path stacked inductor for current compensation of claim 1 comprises: the metal traces are wound in clockwise or counterclockwise direction.
